(19) United States
(12) Patent Application Publication
(10) Pub. No.: US 2015/0180089 A1
(43) Pub. Date: Jun. 25, 2015

(54) HIGH-VOLTAGE BATTERY FOR VEHICLE

(71) Applicant: Hyundai Motor Company, Seoul (KR)

(72) Inventors: Hong Seok Min, Yongin (KR); Seung Ho Ahn, Seoul (KR); Sung Min Choi, Gyeongju (KR)

(21) Appl. No.: 14/457,472

(22) Filed: Aug. 12, 2014

(30) Foreign Application Priority Data
Dec. 19, 2013 (KR) 10-2013-0159577

(51) Int. Cl. H01M 10/42; H01M 10/04

(52) U.S. Cl. CPC H01M 10/42; H01M 10/0431; H01M 2220/20; H01M 2200/00

(57) ABSTRACT

A high-voltage battery for a vehicle is provided. The high-voltage battery includes an electrode assembly that includes a cathode plate, an anode plate, and a separator disposed between the cathode plate and the anode plate. A safety member is coupled to an outer surface of the electrode assembly, and includes a first electrically conductive plate electrically connected to the cathode plate, and a second electrically conductive plate that is electrically connected to the anode plate and has an insulation surface on a surface of the safety member.

### CROSS-REFERENCE TO RELATED APPLICATION

This application claims under 35 U.S.C. §119(a) the benefit of Korean Patent Application No. 10-2013-0159577 filed on Dec. 19, 2013, the entire contents of which are incorporated herein by reference.

### BACKGROUND

1. Field of the Invention

The present invention relates to a high-voltage battery for a vehicle, which is intended to solve several factors threatening safety, such as when a pouch type secondary battery among high-voltage batteries is exposed to an overcharge or substantially high temperature.

2. Description of the Related Art

A rechargeable secondary battery has been receiving attention as a power source of an electric vehicle, a hybrid electric vehicle, etc, which are proposed to solve various problems, such as air pollution caused by existing gasoline vehicles or diesel vehicles that use fossil fuel. Devices, such as vehicles, utilize medium and large sized battery systems with a plurality of battery cells electrically connected to each other, because they require substantially high output and large capacity. A pouch type lithium-ion polymer secondary battery (e.g., high-voltage battery) that is widely used as a unit cell in the medium and large sized battery systems is substantially large in size, is superior in safety, and is light in weight compared to the same type battery used in a small-sized device. Thus, being advantageous to achieve the lightness of a portable electronic device.

However, in the pouch type lithium secondary battery when the battery is penetrated by exterior metal, explosion or ignition may occur due to an interior short-circuit. In particular, when the high-capacity lithium secondary battery for the vehicle, the amount of an interior energy is substantial, thus causing raising a concern regarding penetration safety. A pouch type secondary battery of the related art includes an electrode assembly, a case, an anode tab, a cathode tab, and a connection member. The electrode assembly has an anode plate, a separator and a cathode plate. The case accommodates the electrode assembly therein and has a sealing portion, and is formed by sequentially stacking a thermal fusion layer, a metal layer and an insulation layer. The anode tab is electrically connected to the anode plate, with a tab film surrounding a portion of the anode tab that protrudes outwards from the anode plate. The cathode tab is electrically connected to the cathode plate, with a tab film surrounding a portion of the cathode tab that protrudes outwards from the cathode plate. The connection member serves to electrically connect the metal layer to the anode tab forcibly.

However, even in the above-mentioned pouch type secondary battery, the insulation layer may cause a current discharge delay time that corresponds to a thickness of the insulation layer when the battery is penetrated. The insulation layer between electrically conductive plates inhibits the dissipation of charging or discharging heat generated in a pouch cell, and high current flows in a penetrated portion between the electrically conductive plates when the battery is penetrated. In particular, due to the generation of heat that is suddenly and locally produced around the penetrated portion, a substance of the insulation layer may be deteriorated, thus leading to deformation or expansion. Further, the presence of the safety member may undesirably increase the weight of the pouch cell.

Therefore, there is a need for a high-voltage battery that has minimal delay time due to the insulation layer when the battery is penetrated, has improved heat conductivity between the electrically conductive plates, does not undergo deformation or expansion between the electrically conductive plates, and does not require an increase in weight or size of the pouch cell.

The foregoing is intended merely to aid in the understanding of the background of the present invention, and is not intended to mean that the present invention falls within the purview of the related art that is already known to those skilled in the art.

### SUMMARY

Accordingly, the present invention provides a high-voltage battery for a vehicle, which has minimal delay time due to an insulation layer when penetration occurs, improved heat conductivity between electrically conductive plates, prevents deformation or expansion from occurring between the electrically conductive plates, and prevents the weight or size of a pouch cell from increasing.

According to one aspect of the present invention, a high-voltage battery for a vehicle may include an electrode assembly having a cathode plate, an anode plate, and a separator disposed between the cathode plate and the anode plate; and a safety member coupled to an outer surface of the electrode assembly, the safety member may have a first electrically conductive plate electrically connected to the cathode plate, and a second electrically conductive plate electrically connected to the anode plate and having on a surface thereof an insulation surface.

The electrode assembly may be wound in a form of a jelly roll (e.g., alternating layers). The safety member may form a layer with the first and second electrically conductive plates, with the insulation surface located between the first and second electrically conductive plates. The first electrically conductive plate may be made of copper and the second electrically conductive plate may be made of aluminum. The second electrically conductive plate may be treated by aluminum anodizing to form the insulation surface. In addition, safety member may be formed to have a size that corresponds to an area of the outer surface of the electrode assembly. A first extension may protrude from a side of the first electrically conductive plate of the safety member, and a first electrode tab may protrude from a side of the cathode plate of the electrode assembly, to electrically connect the first extension and the first electrode tab. A second extension may protrude from a side of the second electrically conductive plate of the safety member, and a second electrode tab may protrude from a side of the anode plate of the electrode assembly, to electrically connect the second extension and the second electrode tab.

As is apparent from the above description, the high-voltage battery for the vehicle may increase the physical stiffness of the pouch cell to secure durability required to more effectively perform the modularization of the battery, and, when an interior short-circuit occurs in an abnormal condition such as vehicle collision or external damage, a primary short-circuit path may be formed in the safety member, thus inducing energy discharge without ignition. Further, when an exothermic reaction exceeding a predetermined temperature is carried out, a polymer layer between the safety member and the electrode assembly becomes molten, thus inducing an endothermic reaction and thereby lowering the temperature within the pouch cell.

The high-voltage battery for the vehicle is advantageous in that, in a stacking process of the jelly roll (e.g., alternating layers) that is the electrode assembly, a pre-stacked safety member may be further stacked, thus overcoming the drawback of the conventional pouch cell when penetrated, and obviating the necessity of an additional material except for the first electrically conductive plate and the second electrically conductive plate. Therefore, the high-voltage battery of this invention may eliminate a delay time that corresponds to the conventional insulation plate when the pouch cell is penetrated, thus allowing current to be more rapidly discharged without the delay time due to the penetration.

The high-voltage battery for the vehicle is advantageous in that no additional insulation plate is inserted between the first and second electrically conductive plates in the safety member, to increase heat conductivity between the electrically conductive plates, enhance heat radiation, and prevent deformation or expansion between the electrically conductive plates due to local heat generation when the battery is penetrated. Further, since conductivity may be obtained from both the first and second electrically conductive plates, it may be possible to minimize thickness. Furthermore, the insulation plate may be eliminated, and thus the weight of the insulation plate need not be considered, and thus the entire structure of the pouch cell may be simplified, the cost of the battery may be reduced, and the marketability of the battery may be improved.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view showing a safety member of a high-voltage battery for a vehicle according to an exemplary embodiment of the present invention;

FIG. 2 is an exemplary sectional view taken along line A-A of FIG. 1 according to an exemplary embodiment of the present invention;

FIGS. 3 and 4 are exemplary views showing the top and bottom of an aluminum sheet according to an exemplary embodiment of the present invention;

FIG. 5 is an exemplary view showing the safety member coupled to a jelly roll according to an exemplary embodiment of the present invention; and

FIG. 6 is an exemplary sectional view taken along line B-B of FIG. 5 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

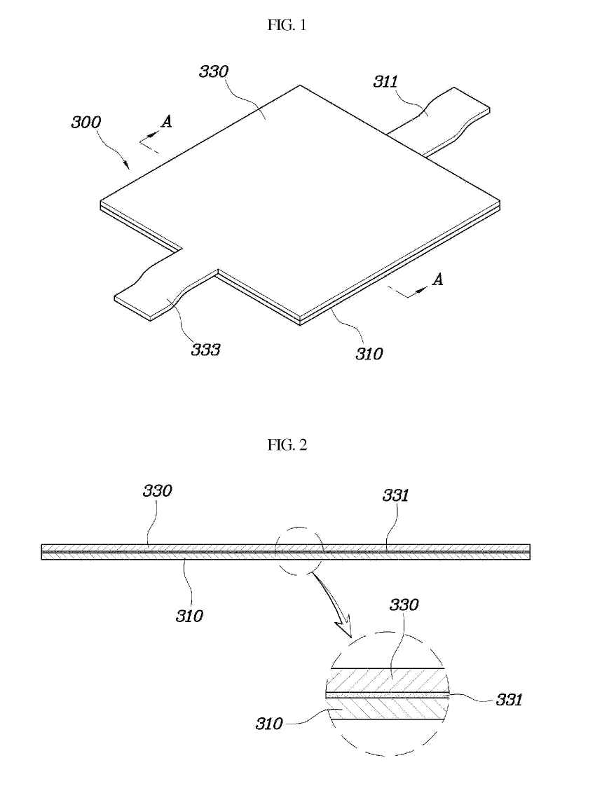

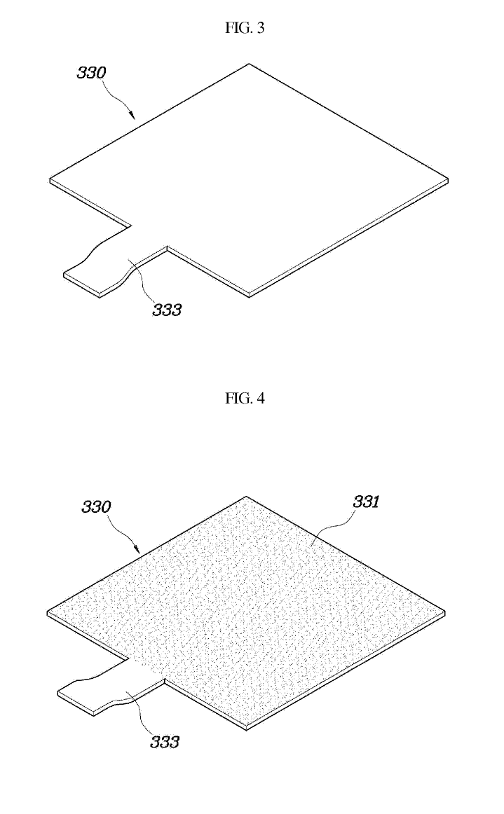

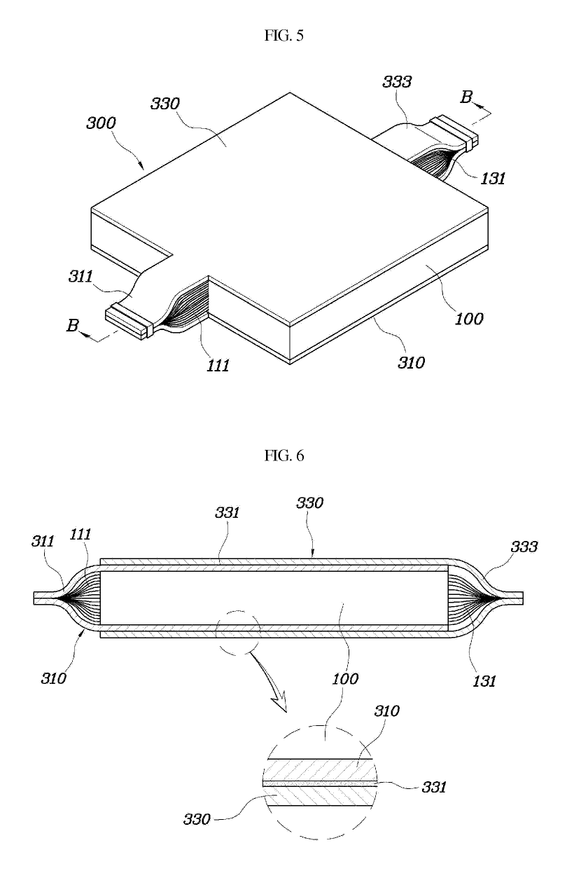

Hereinbelow, a high-voltage battery for a vehicle according to the exemplary embodiment of the present invention will be described with reference to the accompanying drawings. FIG. 1 is an exemplary view showing a safety member 300 of a high-voltage battery for a vehicle according to an exemplary embodiment of the present invention, FIG. 2 is an exemplary sectional view taken along line A-A of FIG. 1, and FIGS. 3 and 4 are exemplary views showing the top and bottom of an aluminum sheet 330. Further, FIG. 5 is an exemplary view showing the safety member 300 coupled to a jelly roll 100, and FIG. 6 is an exemplary sectional view taken along line B-B of FIG. 5.

According to the exemplary embodiment of the present invention, the high-voltage battery may include an electrode assembly 100 and a safety member 300. The electrode assembly 100 may include a cathode plate 110, an anode plate 130, and a separator 150 disposed between the cathode plate 110 and the anode plate 130. The safety member 300 may be coupled to an outer surface of the electrode assembly 100. Further, the safety member 300 may include a first electrically conductive plate 310 electrically connected to the cathode plate 110, and a second electrically conductive plate 330 electrically connected to the anode plate 130 and may have an insulation surface 331 on a surface thereof. The present invention is directed to a pouch type high-voltage battery among high-voltage batteries. The electrode assembly 100 may be wound in the form of a jelly roll 100 (e.g., alternating layers) and then may be sealed in the pouch.

According to this exemplary embodiment, the first electrically conductive plate 310 may be formed of copper, and the second electrically conductive plate 330 may be formed of aluminum. The second electrically conductive plate 330 may be treated by aluminum anodizing to form the insulation surface 331. Unlike the related art wherein the insulation plate is additionally formed between the first and second electrically conductive plates, according to the present invention, the insulation plate may be eliminated and a surface of the second electrically conductive plate 330 of aluminum may be treated by aluminum anodizing, thus forming the insulation surface 331 and offering insulating properties. Consequently, although no insulation plate is separately provided, the first and second electrically conductive plates 310 and 330 may be insulated from each other.

Aluminum anodizing is a post-processing method for an aluminum surface. In particular, this is the technology of coating oxide on the aluminum surface using an artificial electrochemical reaction, based on the principle of natural oxidation occurring when aluminum and oxygen meet each other. When aluminum is connected to an electrode and then is immersed in an electrolyte, an aluminum oxide film is substantially evenly applied. This process is referred to as anodizing. The anodizing is a plating method that may increase corrosion resistance and wear resistance and provide practicality and improved appearance.

Further, a hard anodizing method is the technology that may change a surface into alumina ceramic using an electrochemical method. This method oxidizes aluminum metal itself to be changed into alumina ceramic Thus, the aluminum surface may have improved strength (e.g., may be stronger than steel), and may provide higher wear resistance compared to hard chromium plating, to prevent the surfaces from peeling off like plating or coating. The changed alumina ceramic surface may be useful in electric insulation, and electric current may flow more smoothly through the inside of the surface. Thus, this method has been widely used for parts requiring high wear resistance, for example, a surface of an airplane, an industrial machine, a slide component of industrial facilities, a roller, semiconductor equipment, etc. As such, the second electrically conductive plate 330 of the safety member 300 may be treated by aluminum anodizing, thus advantageously eliminating the conventional insulation plate.

The safety member 300 may be formed by stacking the first and second electrically conductive plates 310 and 330, and the insulation surface 331 of the second electrically conductive plate 330 may be disposed between the first and second electrically conductive plates 310 and 330 to insulate the first and second electrically conductive plates 310 and 330 from each other. The safety member 300 may be formed to have a size that corresponds to an area of the outer surface of the electrode assembly 100, to dispose the safety member 300 in close contact with (e.g., adjacent placement thereof) the upper and lower surfaces of the electrode assembly 100. However, according to circumstances, the safety member 300 may be formed to have a size that corresponds to part of the area of the outer surface of the electrode assembly 100.

Further, a first extension 311 may protrude from a side of the first electrically conductive plate 310 of the safety member 300, and a first electrode tab 111 may protrude from a side of the cathode plate 110 of the electrode assembly 100, to electrically connect the first extension 311 and the first electrode tab 111. A second extension 333 may protrude from a side of the second electrically conductive plate 330 of the safety member 300, and a second electrode tab 131 may protrude from a side of the anode plate 130 of the electrode assembly 100, to electrically connect the second extension 333 and the second electrode tab 131.

In summary, the present invention is intended to prevent explosion, ignition, etc. from occurring due to an interior short-circuit, when the pouch type high-voltage battery is penetrated by exterior metal. Accordingly, the safety member 300 may be coupled to the upper and lower surfaces of the electrode assembly 100 having the form of the jelly roll (e.g., alternating layers or stacking layers). The safety member 300 may be formed by stacking the first electrically conductive plate 310 made of copper and the second electrically conductive plate 330 made of aluminum and including the insulation surface 331 treated by aluminum anodizing Further, the first electrically conductive plate 310 may be electrically connected to the cathode plate 110 of the electrode assembly 100, while the second electrically conductive plate 330 may be electrically connected to the anode plate 130 of the electrode assembly 100.

As described above, the present invention provides a high-voltage battery for a vehicle, which may increase the physical stiffness of a pouch cell to improve durability required to more effectively perform the modularization of the battery, and in which, when an interior short-circuit occurs in an abnormal condition such as vehicle collision or external damage, a primary short-circuit path may be formed in a safety member, thus inducing energy discharge without ignition. Further, when an exothermic reaction that exceeds a predetermined temperature is performed, a polymer layer between the safety member and an electrode assembly may become molten, thus inducing an endothermic reaction and thereby lowering the temperature within the pouch cell.

Additionally, the present invention provides a high-voltage battery for a vehicle, in which, in a stacking process of a jelly roll that is an electrode assembly, a pre-stacked safety member may be further stacked, thus overcoming the drawback of the conventional pouch cell when penetrated, simplifying a process, and obviating the necessity of an additional material except for a first electrically conductive plate and a second electrically conductive plate. Therefore, this high-voltage battery may eliminate a delay time that corresponds to the conventional insulation plate when the pouch cell is penetrated, thus allowing current to be more rapidly discharged without the delay time due to the penetration.

Furthermore, the present invention provides a high-voltage battery for a vehicle, in which an additional insulation plate inserted between first and second electrically conductive plates in a safety member is omitted, thus increasing heat conductivity between the electrically conductive plates, enhancing heat radiation, and preventing deformation or expansion between the electrically conductive plates due to local heat generation when the battery is penetrated. Moreover, since conductivity may be obtained from both the first and second electrically conductive plates, it may be possible to minimize thickness. The insulation plate may be eliminated, and thus the weight consideration of the insulation plate may be eliminated thus, simplifying the structure of the pouch cell, reducing the cost of the battery, and improving the marketability of the battery.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A battery for a vehicle, comprising:
an electrode assembly that includes a cathode plate, an anode plate, and a separator disposed between the cathode plate and the anode plate; and
a safety member coupled to an outer surface of the electrode assembly,
wherein the safety member includes a first electrically conductive plate electrically connected to the cathode plate, and a second electrically conductive plate electrically connected to the anode plate and having an insulation surface on a surface of the safety member.

2. The battery as set forth in claim 1, wherein the electrode assembly is wound in alternating layers.

3. The battery as set forth in claim 1, wherein the safety member forms a layer with the first and second electrically conductive plates and with the insulation surface disposed between the first and second electrically conductive plates.

4. The battery as set forth in claim 1, wherein the first electrically conductive plate is formed of copper.

5. The battery as set forth in claim 1, wherein the second electrically conductive plate is formed of aluminum.

6. The battery as set forth in claim 5, wherein the second electrically conductive plate is treated by aluminum anodizing to form the insulation surface.

7. The battery as set forth in claim 1, wherein the safety member is formed to have a size that corresponds to an area of the outer surface of the electrode assembly.

8. The battery as set forth in claim 1, wherein a first extension protrudes from a side of the first electrically conductive plate of the safety member, and a first electrode tab protrudes from a side of the cathode plate of the electrode assembly, to electrically connect the first extension and the first electrode tab.

9. The battery as set forth in claim 1, wherein a second extension protrudes from a side of the second electrically conductive plate of the safety member, and a second electrode tab protrudes from a side of the anode plate of the electrode assembly, to electrically connect the second extension and the second electrode tab.
